(19) United States
(12) Patent Application Publication
(10) Pub. No.: US 2026/0003376 A1
(43) Pub. Date: Jan. 1, 2026

(54) BIDIRECTIONAL SWITCH SUBSTRATE VOLTAGE CONTROL

(71) Applicant: Texas Instruments Incorporated, Dallas, TX (US)

(72) Inventors: David Baldwin, ALLEN, TX (US); Timothy Merkin, PRINCETON, TX (US); Ujwal Radhakrishna, SAN JOSE, CA (US); Pilsung Park, Richardson, TX (US); Chang Soo Suh, ALLEN, TX (US)

(73) Assignee: Texas Instruments Incorporated, Dallas, TX (US)

(21) Appl. No.: 18/758,129

(22) Filed: Jun. 28, 2024

(51) Int. Cl. G05F 1/46; G05F 3/26

(52) U.S. Cl. CPC G05F 1/468; G05F 3/262

(57) ABSTRACT

In one example, an apparatus comprises a bidirectional switch substrate bias circuit. The bidirectional switch substrate bias circuit comprises: a first switch coupled between a substrate bias terminal and a first switch current terminal, the first switch having a first switch control terminal; a second switch coupled between the substrate bias terminal and a second switch current terminal, the second switch having a second switch control terminal; and a control circuit having first and second inputs and first and second outputs, the first and second inputs coupled to the respective first and second switch current terminals, and the first and second outputs coupled to the respective first and second switch control terminals, the control circuit configured to, responsive to respective states of the first and second inputs, enable one of the first or second switches and disable the other one of the first or second switches.

### BACKGROUND

A bidirectional switch can support bidirectional current flow between two current terminals when it is in the on state and can provide bidirectional voltage blocking between the two switch terminals when it is in the off state. A bidirectional switch may include two control terminals. The voltages at the control terminals and the current terminals can set the on/off states of the bidirectional switch. The operation of the bidirectional switch may also be affected by the substrate voltage of the bidirectional switch.

### SUMMARY

This Summary is provided to introduce examples of disclosed concepts in a simplified form, which are further described below in the Detailed Description including the drawings provided.

According to certain aspects, an apparatus comprises a bidirectional switch substrate bias circuit. The bidirectional switch substrate bias circuit includes a first switch, a second switch, and a control circuit. The first switch is coupled between a substrate bias terminal and a first switch current terminal, the first switch having a first switch control terminal. The second switch is coupled between the substrate bias terminal and a second switch current terminal, the second switch having a second switch control terminal. The control circuit has first and second inputs and first and second outputs, the first and second inputs coupled to the respective first and second switch current terminals, and the first and second outputs coupled to the respective first and second switch control terminals, the control circuit configured to, responsive to respective states of the first and second inputs, enable one of the first or second switches and disable the other one of the first or second switches.

According to certain aspects, an apparatus comprises a first bidirectional switch, a second bidirectional switch, a first substrate bias circuit, and a second substrate bias circuit. The first bidirectional switch has a first current terminal and a second current terminal, the first current terminal coupled to an alternating current (AC) terminal, the second current terminal coupled to a first switching terminal, the first bidirectional switch having a first substrate bias terminal. The second bidirectional switch has a third current terminal and a fourth current terminal, the third current terminal coupled to the AC terminal, and the fourth current terminal coupled to a second switching terminal, the second bidirectional switch having a second substrate bias terminal. The first substrate bias circuit includes: a first switch coupled between the first current terminal and the first substrate bias terminal, the first switch having a first switch control terminal; a second switch coupled between the second current terminal and the first substrate bias terminal, the second switch having a second switch control terminal; and a first control circuit having first and second inputs and first and second outputs, the first and second inputs coupled to the respective first and second current terminals, and the first and second outputs coupled to the respective first and second switch control terminals, the first control circuit configured to, responsive to respective states of the first and second inputs, enable one of the first or second switches and disable the other one of the first or second switches. The second substrate bias circuit includes: a third switch coupled between the third current terminal and the second substrate bias terminal, the third switch having a third switch control terminal; a fourth switch coupled between the fourth current terminal and the second substrate bias terminal, the fourth switch having a fourth switch control terminal; and a second control circuit having third and fourth inputs and third and fourth outputs, the third and fourth inputs coupled to the respective third and fourth current terminals, and the third and second outputs coupled to the respective first and second switch control terminals, the second control circuit configured to, responsive to respective states of the third and fourth inputs, enable one of the third or fourth switches and disable the other one of the third or fourth switches.

According to certain aspects, a method comprises receiving a first voltage at a first current terminal of a bidirectional switch. The method further comprises receiving a second voltage at a second current terminal or a substrate bias terminal of the bidirectional switch. The method further comprises responsive to the first voltage lower than the second voltage, connecting the first current terminal to the substrate bias terminal; and responsive to the second voltage lower than the first voltage, connecting the second current terminal to the substrate bias terminal.

The foregoing summary outlines rather broadly various features of examples of the present disclosure so that the following detailed description may be better understood. Additional features and advantages of such examples will be described hereinafter. This summary is neither intended to identify key or essential features of the claimed subject matters, nor is it intended to be used in isolation to determine the scope of the claimed subject matters. The subject matters should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative examples are described in detail below with reference to the following figures.

FIG. 1 is a schematic of an example of a bidirectional switch.

FIG. 2 is a cross-sectional view of the bidirectional switch of FIG. 1.

FIG. 3 is a schematic of an example of a substrate bias circuit for the bidirectional switch of FIG. 1.

FIG. 4, FIG. 5, FIG. 6, and FIG. 7 are schematics of examples of internal components of the substrate bias circuit of FIG. 1.

FIG. 8 is a schematic of an example of a system including the bidirectional switches of FIGS. 1 and 2 and the substrate bias circuit of FIGS. 3-7.

FIGS. 9A, 9B, and FIG. 10 include graphs that illustrate examples of operations of the system of FIG. 8.

FIG. 11 is a flowchart of an example of a method of operating a bidirectional switch.

The drawings and accompanying detailed description are provided for understanding of features of various examples and do not limit the scope of the appended claims. The examples illustrated in the drawings and described in the accompanying detailed description may be readily utilized as a basis for modifying or designing other examples that are within the scope of the appended claims. One skilled in the art will readily recognize from the following description that alternative embodiments of the structures and methods illustrated may be employed without departing from the principles, or benefits touted, of this disclosure. Identical reference numerals may be used, where possible, to designate identical elements that are common among drawings. The figures are drawn to clearly illustrate the relevant elements or features and are not necessarily drawn to scale.

### DETAILED DESCRIPTION

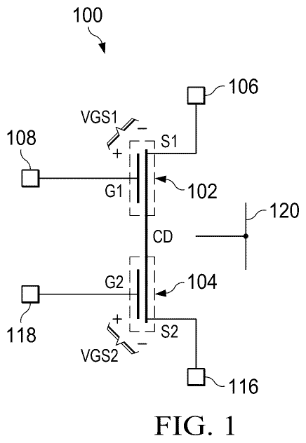

FIG. 1 is a schematic of an example of a bidirectional switch 100. Bidirectional switch 100 includes a switch device 102 and a switch device 104. Switch device 102 includes a current terminal 106 and a switch control terminal 108. Switch device 104 includes a current terminal 116 and a switch control terminal 118. The two transistors forming the switch devices 102 and 104 can share a common drain (labelled CD), which can be inaccessible (e.g., by an electrode or other metal interconnect) to reduce the current path distance between current terminal 106 and current terminal 116, which can reduce the on-resistance of bidirectional switch 100. In some examples, switch control terminals 108 and 118 are coupled to, respectively, the gates G1 and G2 of the two transistors forming switch devices 102 and 104. Also, current terminals 106 and 116 are coupled to, respectively, the sources S1 and S2 of the two transistors. Switch devices 102 and 104 also share a semiconductor substrate, and bidirectional switch 100 may include a substrate bias terminal 120 to set the bias voltage of the semiconductor substrate. In some examples, switch control terminals 108 and 118 are coupled together to form a single switch control terminal.

In some examples, switch devices 102 and 104 are gallium nitride (GaN)-based high electron mobility transistors (HEMTs). Compared to silicon-based transistors, GaN-based HEMTs may have high breakdown field, high electron mobility, low on-state resistance, high current, faster-switching speed, high thermal conductivity, and excellent reverse-recovery performance, and thus may be more suitable for applications where a low-loss and high-efficiency performance may be desired, such as power electronics or radio frequency (RF) circuits. A GaN-based HEMT may allow current to flow from the drain to source and vice versa when the HEMT is turned on (in the ON state), may block the current flow from the drain to source when the HEMT is turned off (in the OFF state), and may have lower static on-state resistance (and thus lower voltage drop and lower power loss) than MOSFETs due to, for example, the high electron mobility. Therefore, GaN-based HEMTs may be suitable for use in bidirectional switches and may offer higher switching speed and lower power loss and voltage drop. In addition, due to the lateral device structure and the nonexistence of body diodes in GaN-based HEMTs, it can be relatively easy to fabricate monolithic bidirectional switches implemented using GaN-based HEMTs.

Bidirectional switch 100 can support bidirectional current flow between current terminals 106 and 116 when both switch devices 102 and 104 are turned on, and can provide bidirectional voltage blocking when at least one of switch devices 102 and 104 is turned off. Bidirectional switch 100 may be used, for example, as a bidirectional power switch for charger multiplexing, where the bidirectional switch may be turned on to charge a battery using a current from a power supply to the battery, or to provide a current from the battery to a load. The bidirectional switch may also be turned off to block current in either direction, for example, to avoid draining a charged battery or prevent one battery from charging another battery.

Another example application of bidirectional switch 100 is in a switch-mode converter, such as an alternating current (AC) to direct current (DC) converter, an AC cycloconverter, etc. In such application, as to be described below, the voltage across the bidirectional switch can be an AC voltage that changes polarity between a positive half cycle and a negative half cycle. For example, in a positive half cycle, the voltage at current terminal 106 can be higher than the voltage at current terminal 116, and in a negative half cycle, the voltage at current terminal 106 can be lower than the voltage at current terminal 116. In such application, bidirectional switch 100 may be turned on to enable a current to flow between current terminals 106 and 116, or to block a current (and/or a voltage) between current terminals 106 and 116, in both the positive and negative half cycles.

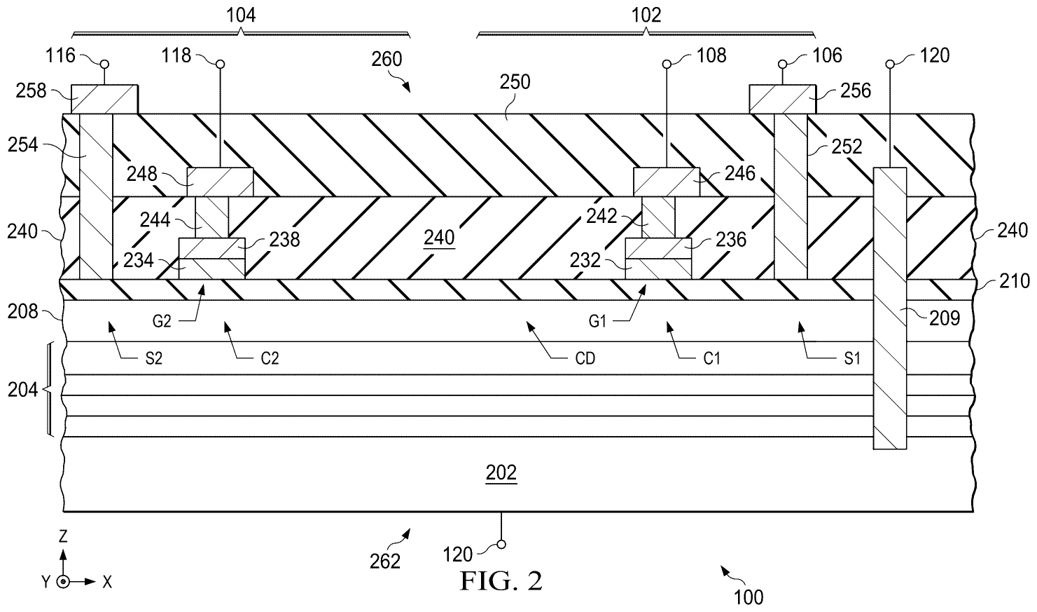

FIG. 2 illustrates an example of a cross section view of bidirectional switch 100. FIG. 2 shows a semiconductor substrate 202, a channel layer 208, and a barrier layer 210. Specifically, the semiconductor substrate 202 may be a bulk semiconductor substrate, a semiconductor-on-insulator (SOI) substrate, or any other appropriate substrate. For example, the semiconductor substrate 202 may be or include bulk silicon wafer. The channel layer 208 is configured, possibly in conjunction with the barrier layer 210, to conduct and confine charge carriers within two dimensions. In some examples, the charge carriers that the channel layer 208 is configured to conduct and confine are electrons. The channel layer 208 is configured to include a two-dimensional electron gas (2DEG) in various examples. More generally, the channel layer 208 is configured to conduct a charge of a first polarity that is opposite from a second polarity of a charge that the conductive barrier structure 206 is configured to conduct. In some examples, the channel layer 208 includes a gallium nitride (GaN) layer and, in such examples, may be referred to as a GaN channel layer 208 or GaN layer 208. In some examples, the material of the channel layer 208 is or includes an unintentionally doped material, such as a material doped by diffusion of dopants from another layer. The barrier layer 210, in some examples, may be or include an AlGaN layer, or an aluminum nitride (AlN) layer.

A first gate layer 232 is over and on an upper surface of the barrier layer 210, and a second gate layer 234 is over and on an upper surface of the barrier layer 210. A first gate metal layer 236 is over and on the first gate layer 232, and a second gate metal layer 238 is over and on the second gate layer 234. The gate layers may be or include, in some examples, a p-doped gallium nitride (pGaN) layer. The gate metal layers may be or include, in some examples, aluminum nitride (AlN).

The switch device 102 includes a first source region S1, a first channel region C1, a common drain region CD, and a first gate structure G1. The second switching device 104 includes a second source region S2, a second channel region C2, the common drain region CD, and a second gate structure G2. The first gate structure G1 includes the first gate layer 232 and the first gate barrier layer 236. The first channel region C1 is in the channel layer 208 underlying the first gate structure G1. The first channel region C1 is laterally between the first source region S1 and the common drain region CD, which are also in the channel layer 208. The second gate structure G2 includes the second gate layer 234 and the second gate barrier layer 238. The second channel region C2 is in the channel layer 208 underlying the second gate structure G2. The second channel region C2 is laterally between the second source region S2 and the common drain region CD, which are also in the channel layer 208. The common drain region CD is laterally between (i) the first gate structure G1 and first channel region C1 and (ii) the second gate structure G2 and second channel region C2. The first source region S1, first gate structure G1, common drain region CD, second source region S2, and second gate structure G2 correspond to the first source terminal S1, first gate terminal G1, common drain CD, second source terminal S2, and second gate terminal G2, respectively, of FIG. 2.

A first dielectric layer 240 is over and on the barrier layer 210 and gate barrier layers 236, 238 and along sidewalls of the gate layers 232, 234 and gate barrier layers 236, 238. A first gate electrical contact 242 extends through the first dielectric layer 240 and contacts the first gate barrier layer 236, and a second gate electrical contact 244 extends through the first dielectric layer 240 and contacts the second gate barrier layer 238. A metal line 246 in a first metal layer is over and on the first gate electrical contact 242 and an upper surface of the first dielectric layer 240, and a metal line 248 in the first metal layer is over and on the second gate electrical contact 244 and the upper surface of the first dielectric layer 240.

In a case where bidirectional switch 100 includes enhancement mode (E-mode) HEMTs, first gate layer 234, first gate metal layer 238, and first gate electrical contact 244 form a Schottky contact, or an ohmic contact, with an underlying layer(s), and the second gate layer 232, second gate metal layer 236, and second gate electrical contact 242 form a Schottky contact, or an ohmic contact, with an underlying layer(s). In a case where bidirectional switch 100 includes depletion mode (D-mode) HEMTs, first gate layer 232 and first gate barrier layer 236 are absent, and second gate layer 234 and second gate barrier layer 236 are absent. First gate electrical contact 242 and second gate electrical contact 244 are over and separated from barrier layer 210 by a dielectric (insulator layer) to form metal insulator semiconductor (MIS) gate structures. In some examples, as described above, first gate electrical contact 242 and second gate electrical contact 244 can be electrically coupled together (e.g., through metal lines 246 and 248) to form a single gate/switch control terminal.

A second dielectric layer 250 is over and on the first dielectric layer 240 and the metal lines 256, 258. A first source electrical contact 252 extends through the second dielectric layer 250 and first dielectric layer 240 and contacts the barrier layer 210 on the first source region S1. A second source electrical contact 254 extends through the second dielectric layer 250 and first dielectric layer 240 and contacts the barrier layer 210 on the second source region S2. Metal lines 256, 258 in a second metal layer are over and on the source electrical contacts 252, 254, respectively, and an upper surface of the second dielectric layer 250.

Additional dielectric layers and metal layers may be formed on and over the second dielectric layer 250. The first dielectric layer 240, additional dielectric layers, first metal layer, second metal layer, and additional metal layers may form an interconnect structure. Metal lines in neighboring metal layers may be electrically coupled by metal vias.

The metal line 256 is electrically coupled to the current terminal 106 of bidirectional switch 100. The metal line 258 is electrically coupled to the current terminal 116 of bidirectional switch 110 through the interconnect structure. The metal line 246 is electrically coupled to the first control terminal 108 of bidirectional switch 100 through the interconnect structure. The metal line 248 is electrically coupled to the second control terminal 118 of bidirectional switch 100 through the interconnect structure.

In the examples of FIGS. 1 and 2, the HEMTs of switch devices 102 and 104 are enhancement mode devices. The pGaN gate layers 232 and 234 can deplete electrons in the 2DEG channel under the respective gate structures G1 and G2, and switch devices 102 and 104 are disabled when no gate drive voltage is applied to the gate electrical contacts 242 and 244. To turn on a switch device, a positive voltage difference can be applied between the gate and source of the switch device. If the positive voltage difference exceeds a threshold voltage (e.g., of the Schottky contact), the gate structure can attract electrons to replete the 2DEG and form a channel under the gate structure, thereby turning on the HEMT and the switch device. For example, switch device 102 can be turned on if a voltage difference between the switch control terminal 108 and the current terminal 106 (coupled to gate G1 and source S1 respectively), VGS1, exceeds a threshold. Also, switch device 104 can be turned on if a voltage difference between the switch control terminal 118 and the current terminal 116 (coupled to gate G2 and source S2 respectively), VGS2, exceeds a threshold.

In some examples, the semiconductor substrate 202 is electrically coupled to substrate bias terminal 120 via an electrode 209, which can penetrate through channel layer 208 and barrier layer 210. In such examples, substrate bias terminal 120 can be on the back side 260 of semiconductor substrate 202 and on the same side as current terminals 106/116 and control terminals 108/118. As to be described below, substrate bias terminal 120 can be connected to other circuitries on semiconductor die 202 via metal lines in dielectric layers 240 and 250. In some examples, substrate bias terminal 120 can be on front side 262 of semiconductor substrate 202. In such examples, substrate bias terminal 120 can be coupled to a die attach pad and electrically coupled to other circuitries via, for example, package thermal pad and down-bonds.

Substrate bias terminal 120 can receive a voltage and set a bias voltage of semiconductor substrate 202 based on the received voltage. To reduce backgating, substrate bias terminal 120 may not be hard-tied (or permanently tied) to one of sources S1 or S2 (and current terminals 106 or 116).

Backgating occurs when the substrate voltage of the bidirectional switch experiences a positive or a negative swing relative to source regions S1/S2 as source voltages switch. The substrate voltage may modulate the channel of the switch devices of the bidirectional switch and prevent the switch devices from switching. Hard-tying the substrate (or substrate bias terminal 120) to one of the source regions S1/S2 can further worse the effect of backgating. For example, if the voltage of source region S1 (VS1) is higher than the voltage of source region S2 (VS2), and substrate bias terminal 120 is hard-tied to source region S1 (or current terminal 114), the high VS1 (or a substrate voltage caused by VS1) can modulate the channel of switch device 104 and prevent switch device 104 from turning on. Also, if the voltage of source region S2 (VS2) is higher than the voltage of source region S1 (VS1), and semiconductor substrate 202 is hard-tied to source region S2 (or current terminal 116), the high VS2 (or a substrate voltage caused by VS2) can modulate the channel of switch device 102 and prevent switch device 102 from turning on.

One way to mitigate the effect of backgating is by having semiconductor substrate 202 and substrate bias terminal 120 floating. Such arrangements, however, may still allow voltages at the source regions (e.g., VS1, VS2) to couple into the channel regions (e.g., C1 or C2) via the parasitic capacitance between the source regions and semiconductor substrate 202. Moreover, with semiconductor substrate 202 floating, there may lack a fast discharge path for the charge accumulated in semiconductor substrate 202 due to the source voltage coupling. Accordingly, the substrate charge may remain for an extended period of time, and the substrate voltage may still modulate the channel of switch devices 102/104 and prevent the switching of the switch devices.

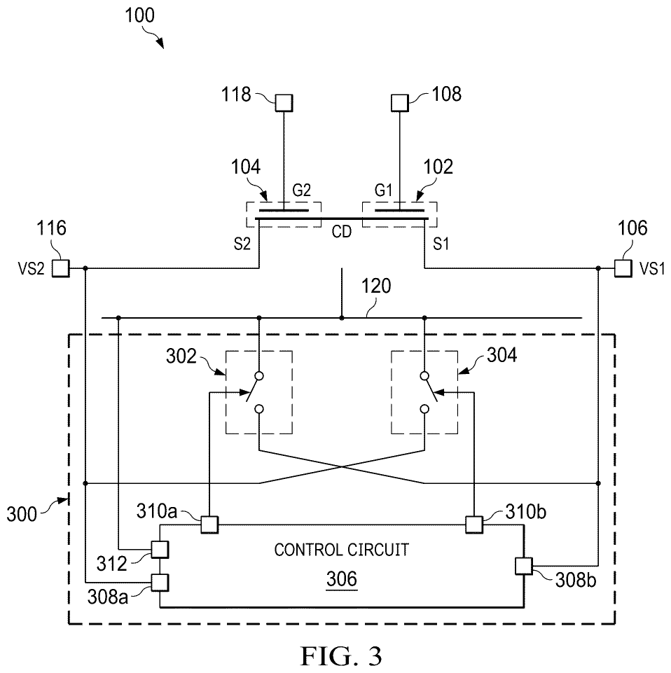

FIG. 3 illustrates an example of a substrate bias circuit 300 that can address at least some of the issues described above. As shown in FIG. 3, substrate bias circuit 300 includes a switch 302, a switch 304, and a control circuit 306. Switch 302 is coupled between substrate bias terminal 120 and current terminal 106. Switch 304 is coupled between substrate terminal 122 and current terminal 106. Each of switches 302 and 304 can be an active switch implemented using a transistor, such as a FET, an HEMT, etc. Control circuit 306 has inputs 308, outputs 310, and a reference terminal 312. Inputs 308 may include inputs 308a and 308b. Outputs 310 may include outputs 310a and 310b. Input 308a is coupled to current terminal 116. Input 308b is coupled to current terminal 106. Output 310a is coupled to a control terminal of switch 302, and output 310b is coupled to a control terminal of switch 304. Reference terminal 312 is coupled to substrate bias terminal 120.

Control circuit 306 can sense the voltages of current terminals 106 and 116 and, in some examples, the substrate voltage via substrate bias terminal 120. Control circuit 306 can selectively enable one of switches 302 or 304 to connect substrate bias terminal 120 to one of current terminals 106 or 116 based on the sensed voltages. In some examples, control circuit 306 can enable one of switches 302 or 304 to connect substrate bias terminal 120 to the one of current terminals 106 or 116 having the lower voltage among current terminals 106 and 116. For example, if the voltage at current terminal 106 (source voltage VS1) is lower than the voltage at current terminal 116 (source voltage VS2) or the current substrate voltage, which reflects the higher source voltage, control circuit 306 can enable switch 302 to connect substrate bias terminal 120 to current terminal 106, so that the substrate voltage can be reduced to (or can be set based on) the lower voltage at current terminal 106. Also, if the voltage at current terminal 116 (VS2) is lower than the voltage at current terminal 106 (VS1) or the current substrate voltage, control circuit 306 can enable switch 304 to connect substrate bias terminal 120 to current terminal 116, so that the substrate voltage can be reduced to (or can be set based on) the lower voltage at current terminal 116. In a case where the voltages at current terminals 106 and 106 are equal, control circuit 306 can enable one of switches 302 or 304, and disable the other one of switches 302 or 304, to avoid creating a leakage path between current terminals 106 and 116 (and bypass switch devices 102 and 104) through switches 302 and 304 and bias terminal 120, which can increase standby power and reduce efficiency when both switch devices 102 and 104 are off.

In some examples, substrate bias circuit 300 is monolithically integrated on the same semiconductor die as bi-directional switch 100. For example, switch devices 102 and 104 of bidirectional switch 100, switch 302, switch 304, and control circuit 306 can include HEMTs implemented on semiconductor substrate 202 and channel layer 208 of FIG. 2, and substrate bias circuit 300 can be coupled to substrate bias terminal 120 on back side 260 of semiconductor substrate 202. In some examples, bidirectional switch 100 and substrate bias circuit 300 can be implemented on different semiconductor dies and/or in different semiconductor packages, and substrate bias circuit 300 can be coupled to substrate bias terminal 120 on front side 262 via, for example, package thermal pad and down-bonds.

Substrate bias circuit 300 can mitigate backgating by setting/steering the substrate voltage to the lower one among the source voltages VS1 and VS2, and by switching the substrate voltage to follow the switching of the source voltages. Specifically, by setting the substrate voltage to the lower one among the source voltages VS1 and VS2, the aforementioned issue of channel modulation of switch devices caused by a high source voltage can be reduced. Moreover, by switching the substrate voltage to following the switching of the source voltages, the positive/negative swing of the substrate voltage relative to source regions of the bidirectional switch can be reduced, and backgating can be mitigated as well.

Also, using active switches 302 and 304 (e.g., transistors) to steer the substrate voltage, rather than passive devices (e.g., diodes), can provide various advantages. Specifically, diodes are much larger than transistors to achieve the same resistance. Using transistors to steer the substrate voltage can reduce the overall footprint of substrate bias circuit 300 and allow switches 302 and 304 to be monolithically integrated with bidirectional switch 100 on a same semiconductor die. Transistors also have lower charge and allow faster switching than diodes, which allows the substrate voltage to quickly settle to the target voltage (e.g., minimum of the source voltages VS1 and VS2) as VS1/VS2 switches, thereby reducing the positive/negative substrate voltage transient swings relative to VS1/VS2 during switching. Also, a diode can conduct a forward current from its anode to its cathode while blocking the flow of current in the opposite direction. In contrast, a transistor can conduct current across its current terminals in both directions, and switches 302/304 implemented using a transistor can conduct both negative charge and positive charge from semiconductor substrate 120 to one of current terminals 106/116.

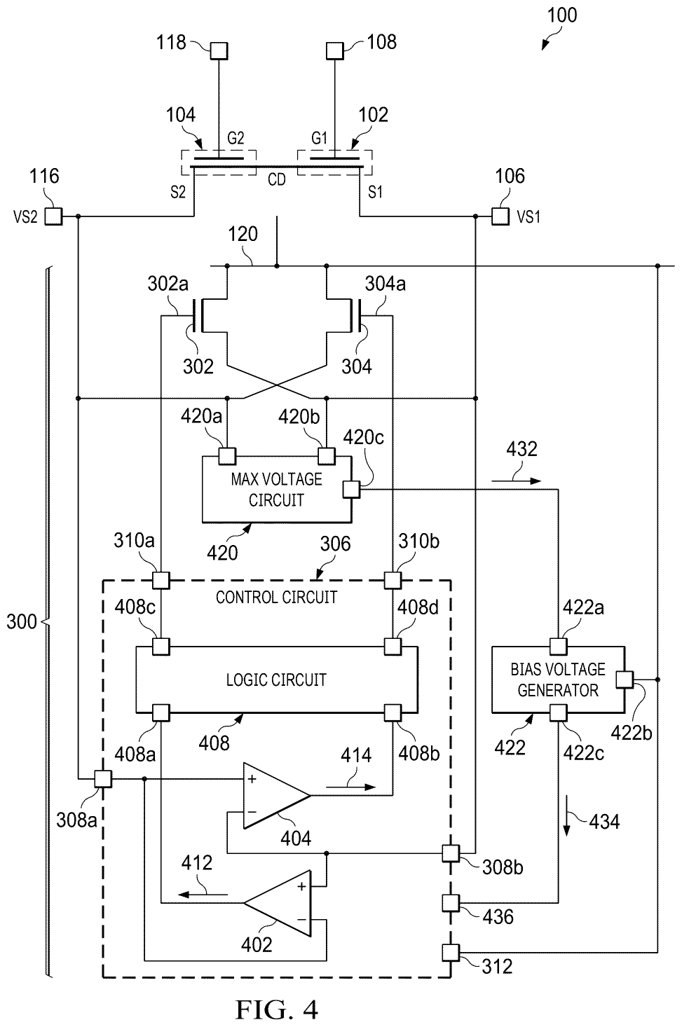

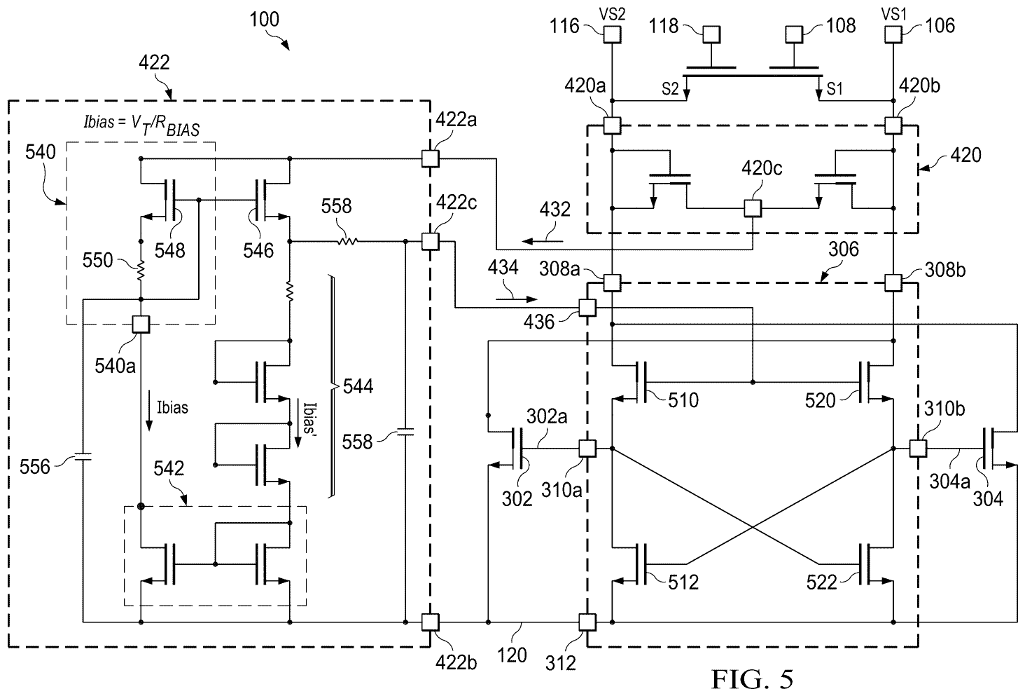

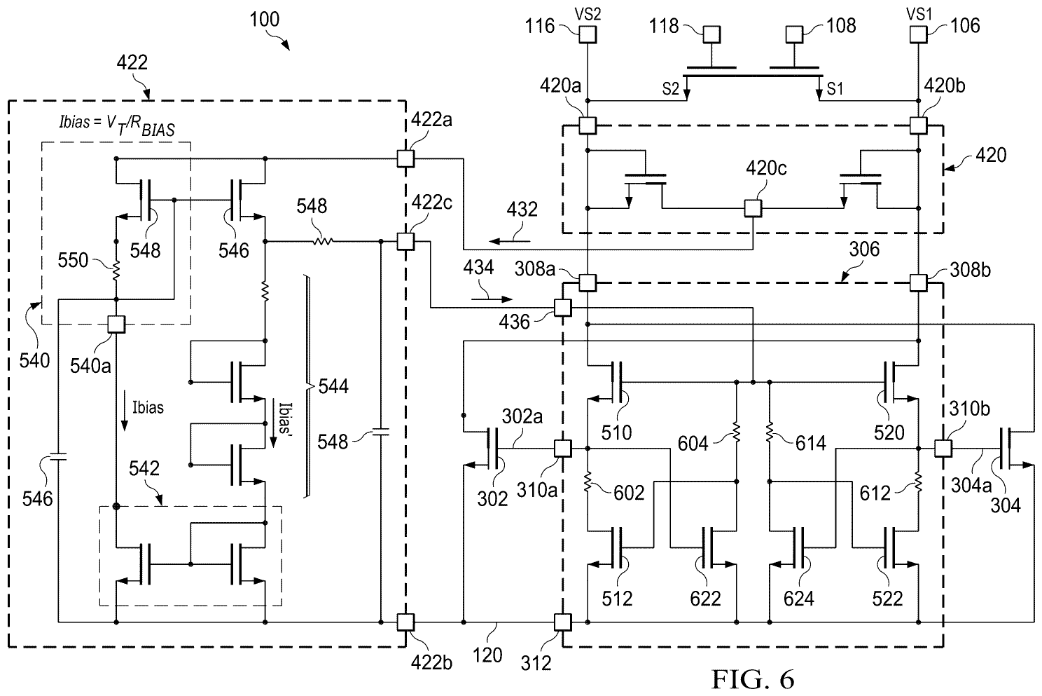

FIG. 4 illustrates examples of internal components of substrate bias circuit 300. As shown in FIG. 4, each of switches 302 and 304 can include a transistor, such as an NFET, an enhancement-mode HEMT, etc. Also, control circuit 306 includes a comparator 402, a comparator 404, and a logic circuit 408. The negative input of comparator 402 and the positive input of comparator 404 are coupled to current terminal 116 via input 308a. Also, the positive input of comparator 402 and the negative input of comparator 404 are coupled to current terminal 106 via input 308b. Comparator 402 provides a signal 412 representing a comparison between the voltage at current terminal 116 (VS1) and the voltage at current terminal 116 (VS2). If VS1 is lower than VS2, signal 412 can be in the asserted/logical high state, otherwise signal 412 can be in the deasserted/logic low state. Also, comparator 404 provides a signal 414 representing a comparison between VS1 and VS2. If VS2 is lower than VS1, signal 414 can be in the asserted/logic high state, otherwise signal 414 can be in the deasserted/logic low state.

Also, logic circuit 408 has inputs 408a and 408b and outputs 408c and 408d. Input 408a is coupled to the output of comparator 402 to receive signal 412, and input 408b is coupled to the output of comparator 404 to receive signal 414. Output 408c is coupled to control terminal 302a (e.g., gate) of transistor, and output 408d is coupled to control terminal 304a (e.g., gate) of transistor 304. Logic circuit 408 can forward signal 412 to control terminal 302a of transistor 302, and forward signal 414 to control terminal 304a of transistor 304, if signals 412 and 414 have different states indicating that VS1 and VS2 are unequal. If signal 412 is in the asserted/logic high state and signal 414 is in the deasserted/logic low state, which indicate that VS1 is lower than VS2, transistor 302 can be enabled to connect substrate bias terminal 120 to current terminal 106 and set the substrate voltage to (or based on) VS1. If signal 414 is in the asserted/logic high state and signal 412 is in the deasserted/logic low state, which indicate that VS2 is lower than VS1, transistor 304 can be enabled to connect substrate bias terminal 120 to current terminal 116 and set the substrate voltage to (or based on) VS2. But if both signals 412 and 414 are asserted or deasserted, logic circuit 408 can forward one of the asserted signals to enable one of the transistors 302 and 304 (e.g., transistor 302) and forward a deasserted signal to disable the other one of the transistors (e.g., transistor 304).

Further, substrate bias circuit 300 may include a maximum voltage circuit 420 and a bias voltage generator 422. Maximum voltage circuit 420 has inputs 420a and 420b and an output 420c. Inputs 420a and 420b are coupled to, respectively, current terminals 106 and 116. Bias voltage generator 422 has inputs 422a and 422b and an output 422c. Input 422a is coupled to the output 420c of maximum voltage circuit 420. Input 422b is coupled to substrate bias terminal 120. Maximum voltage circuit 420 can provide a voltage 432 based on a maximum between VS1 and VS2 to bias voltage generator 422, so that voltage 432 exceeds the substrate voltage. From voltage 432, bias voltage generator 422 can generate a voltage 434 that is offset from the substrate voltage, and provide voltage 434 to a bias input 436 of control circuit 306. In some examples, voltage 434 can be provided to logic circuit 408 and comparators 402 and 404 as a bias voltage. Reference terminal 312 is coupled to substrate bias terminal 120, which provides the substrate voltage as the ground reference for comparators 402 and 404 and logic circuit 408 and is coupled to FIG. 5 illustrates additional examples of internal components of substrate bias circuit 300. Referring to FIG. 5, control circuit 306 includes a transistor 510 coupled between input 308a and output 310a, and a transistor 512 coupled between output 310a and reference terminal 312/substrate bias terminal 120. Control circuit also includes a transistor 520 coupled between input 308b and output 310b, and a transistor 522 coupled between output 310b and reference terminal 312/substrate bias terminal 120. The control terminals of transistors 510 and 520 are coupled to bias input 436. The control terminal of transistor 512 is coupled to output 310b, and the control terminal of transistor 522 is coupled to output 310a.

Transistors 510, 512, 520, and 522 collectively provide similar function as comparators 402, 404, and logic circuit 408. Specifically, transistor 510 is enabled, based on voltage 434, to transmit the source voltage VS2 to output 310a, and transistor 520 is also enabled, based on voltage 434, to transmit the source voltage VS1 to output 310b. Accordingly, transistor 510 can transmit current from current terminal 116 to charge control terminal 302a to pull up the voltage of control terminal 302a. Also, transistor 520 can transmit current from current terminal 106 to charge control terminal 304a to pull up the voltage of control terminal 304a. Such arrangements can improve the speed at which transistors 302 and 304 are enabled to steer the substrate voltage as the source voltages VS1/VS2 switch.

In addition, the pull down (and discharging) of the control terminals 302a/302b are handled by transistors 512 and 522. The substrate voltage is at a lower voltage among the source voltages VS1 and VS2. If VS2 exceeds the substrate voltage by at least the threshold voltage of transistor 302 (Vt), the voltage at output 310a (and the control terminal 302a) also exceeds the substrate voltage by Vt. Transistor 302 can be enabled to connect substrate bias terminal 120 to current terminal 106 to set the substrate voltage based on the source VS1 at current terminal 106. Also, transistor 522 can be enabled to pull down the respective voltages of output 310b, control terminal 304a of transistor 304, and the control terminal of transistor 512. Accordingly, transistor 304 is disabled, and substrate bias terminal 120 is disconnected from current terminal 116. Also, transistor 512 is disabled and does not pull down the voltage at output 310a, which allows the voltage at output 310a to remain at VS2 and to enable transistor 302.

On the other hand, if VS1 exceeds the substrate voltage by at least Vt, the voltage at output 310b (and the control terminal 304a) also exceeds the substrate voltage by Vt. Transistor 304 can be enabled to connect substrate bias terminal 120 to current terminal 116 to set the substrate voltage based on the source VS2 at current terminal 116. Also, transistor 512 can be enabled to pull down the respective voltages of output 310a, control terminal 302a of transistor 302, and the control terminal of transistor 522. Accordingly, transistor 302 is disabled, and substrate bias terminal 120 is disconnected from current terminal 106. Also, transistor 522 is disabled and does not pull down the voltage at output 310a, which allows the voltage at output 310a to remain at VS2 and to enable transistor 302.

In some examples, a small width offset can be introduced between transistors 512 and 522 to have different driving strengths, so that if VS1 and VS2 are equal, the transistor with a larger driving strength (e.g., transistor 512) can pull down one of the outputs (e.g., 310a) to avoid enabling both transistors 302 and 304.

Also, maximum voltage circuit 420 includes a pair of diode-connected transistors 530 and 532, where the control terminal and a first current terminal of transistor 530 are coupled together (forming an anode) at input 420a, the control terminal and a first current terminal of transistor 532 are coupled together (forming an anode) at input 420b. A second current terminal of transistor 530 and a second current terminal of transistor 532 (forming the cathodes) are coupled to output 420c. Any one of the diode-connected transistors 530/532 can conduct if its anode voltage is higher than the cathode voltage, so that voltage at output 420c represents the maximum voltage among the voltages at inputs 402a and 402b (VS1 and VS2).

Further, bias voltage generator 422 includes a bias current generator circuit 540 having an output 540a, a current mirror 542, a current source 546, a set of serially-connected current-voltage generator circuits 544. Bias current generator circuit 540 and current mirror 542 are coupled between input 422a (coupled to output 420c of maximum voltage circuit 420) and input 422b (coupled to substrate bias terminal 120). Current source 546 and the set of serially-connected current-voltage generator circuits 544 are also coupled between inputs 422a and 422b. Bias current generator circuit 540 includes a transistor 548 and a resistor 550 coupled between input 422a and output 540a, where the control terminal of transistor 548 is coupled to output 540a. Bias current generator circuit 540 can generate a bias current I_{bias} that is based on a ratio between the threshold voltage V_{T} of transistor 548 and the resistance of resistor 550 (R_{BIAS}). Because the voltage at input 422a is a maximum voltage among the source voltages VS1 and VS2, the voltage at input 422a exceeds the voltage at input 422b (the substrate voltage), the bias current I_{bias} can flow from bias current generator circuit 540 to current mirror 542. In some examples, transistor 548 can be a depletion mode (D-mode) transistor, such as a D-mode HEMT or a D-mode FET. Other transistors of bias voltage generator 422, as well as the transistors of maximum voltage circuit 420 and control circuit 306, can be enhancement mode (E-mode) transistors, such as E-mode HEMTs or E-mode FETs.

Current source 546 includes a transistor having a gate/control terminal coupled to output 540a, and current source 546 can provide a bias current I_{bias}′ that is substantially the same as I_{bias}. Because the voltage at input 422a exceeds the voltage at input 422b, the bias current I_{bias}′ can also flow from current source 546 through the set of serially-connected current-voltage generator circuits 544. Current mirror 542 is also coupled to output 540a and the set of serially-connected current-voltage generator circuits 544 to improve the matching between bias currents I_{bias} and I_{bias}′.

The set of serially-connected current-voltage generator circuits 544, including a resistor and two diode-connected transistors, together with the diode-connected transistor of current mirror 542, can convert the bias current Ig′ to a voltage offset from the substrate voltage, so that the bias voltage 434 exceeds the substrate voltage by the voltage offset. The voltage offset is set based on the bias current Ig′ together with a sum of the threshold voltages of the diode-connected transistors, which can reduce the variation of the voltage offset due to process, voltage, and temperature (PVT) variations. Also, with the voltage offset exceeding the substrate voltage by multiple thresholds, it can be ensured that the gate-source voltages of transistors 510 and 520 exceed the respective threshold voltages of transistors 510 and 520, so that the transistors are enabled to transmit the VS1 and VS2 voltages to, respectively, outputs 310a and 310b. Further, bias voltage generator 422 includes filter circuits 556 and 558 at output 540a and output 422c to reduce ripples/noises caused by the switching of source voltages VS1 and VS2.

FIG. 6 illustrates additional examples of internal components of control circuit 306. Referring to FIG. 6, control circuit 306 includes, in addition to transistors 510, 520, 512, and 522, a resistor 602, a resistor 604, a resistor 612, a resistor 614, a transistor 622, and a transistor 624. Resistor 602 is coupled between output 310a and transistor 512. Resistor 604 is coupled between bias input 436 and a control terminal of transistor 512, and transistor 622 is coupled between the control terminal of transistor 512 and reference terminal 312 (coupled to substrate bias terminal 122). The control terminal of transistor 622 is coupled to output 310a. Also, resistor 612 is coupled between output 310b and transistor 522. Resistor 614 is coupled between bias input 436 and a control terminal of transistor 522, and transistor 624 is coupled between the control terminal of transistor 522 and reference terminal 312 (coupled to substrate bias terminal 122). The control terminal of transistor 624 is coupled to output 310b.

In the example of FIG. 6, transistors 512 and 622 operate as a latch to set the state of output 310a, and transistors 522 and 624 operate as a latch to set the state of output 310b. Specifically, transistor 510 transmits the source voltage VS2 to output 310a. If VS2 exceeds the substrate voltage by at least the threshold voltage of transistor 622, transistor 622 can be enabled to pull down the voltage at the control terminal of transistor 512 and disable transistor 512. This allows the voltage of output 310a to stay at VS2 to enable transistor 302 without being pulled down by transistor 512. On the other hand, if VS2 does not exceed the substrate voltage by at least the threshold voltage of transistor 622, transistor 622 is off, and the voltage of the control terminal of transistor 512 can be pulled up by voltage 434. This enables transistor 512 to pull down the voltage of output 310a and disable transistor 302. Resistors 602 and 604 can set the respective current through transistors 512 and 622 when either transistor is on.

Also, if VS1 exceeds the substrate voltage by at least the threshold voltage of transistor 624, transistor 624 can be enabled to pull down the voltage at the control terminal of transistor 522 and disable transistor 522. This allows the voltage of output 310b to stay at VS1 to enable transistor 304 without being pulled down by transistor 522. On the other hand, if VS1 does not exceed the substrate voltage by at least the threshold voltage of transistor 624, transistor 624 is off, and the voltage of the control terminal of transistor 522 can be pulled up by voltage 434. This enables transistor 522 to pull down the voltage of output 310b and disable transistor 304. Resistors 612 and 614 can set the respective current through transistors 522 and 624 when either transistor is on.

FIG. 7 illustrates additional examples of internal components of logic circuit 408. As shown in FIG. 7, logic circuit 408 includes an AND gate (or a comparator) 702, an inverter 704, a switch 706, and a switch 708. The inputs of AND gate 702 are coupled to current terminals of transistors 510 and 520. The output of AND gate 702 is coupled to a switch control terminal of switch 706 and the input of inverter 704. The output of inverter 704 is coupled to a switch control terminal of switch 708. Switch 706 is coupled between output 310a and reference terminal 312 (coupled to substrate bias terminal 120). Switch 708 is coupled between output 310a and the current terminal of transistor 510. If VS1 and VS2 are equal, AND gate 702 can enable switch 706, while inverter 704 can disable switch 708 to disconnect output 310a from VS2. Accordingly, the voltage of output 310a is set at the substrate voltage and turns off transistor 302, so that transistors 302 and 304 are not enabled together. On the other hand, if VS1 and VS2 are not equal, AND gate 702 can disable switch 706, while inverter 704 can enable switch 708 to connect output 310a to VS2, and the state of transistor 302 can be set based on whether VS2 exceeds the substrate voltage by at least a threshold voltage as described above.

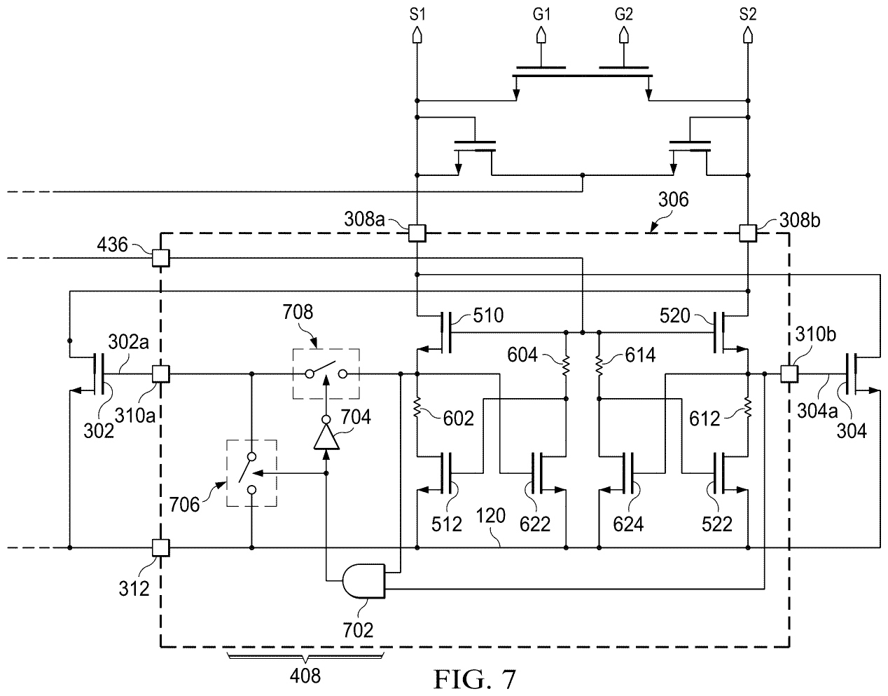

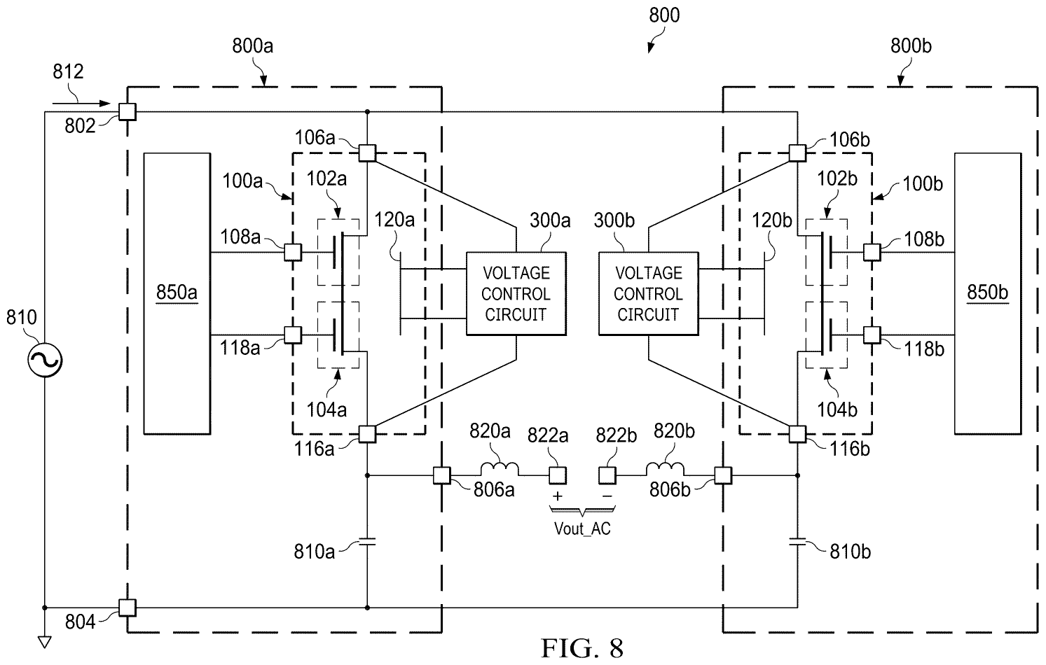

As described above, bidirectional switch 100 can be used as part of a power converter, where the voltage across current terminals 106 and 116 of bidirectional switch 100 switches polarity. FIG. 8 illustrates an example of an AC cycloconverter 800 including bidirectional switches 100. Referring to FIG. 8, AC cycloconverter 800 has an AC terminal 802, an AC terminal 804, and a pair of switching terminals 806a and 806b. AC cycloconverter 800 includes circuits 802a and 802b. Circuit 802a includes a bidirectional switch 100a and a capacitor 810a, and circuit 802b includes a bidirectional switch 100b and a capacitor 810b. Each of bidirectional switch 100a and bidirectional switch 100b can be an example of bidirectional switch 100 of FIG. 1. Bidirectional switch 100a includes switch devices 102a and 104a and has a current terminal 106a coupled to AC terminal 802 and a current terminal 116a coupled to switching terminal 806a, and capacitor 810a is coupled between switching terminal 806a and AC terminal 804. Bidirectional switch 100a also has a substrate bias terminal 120a. Bidirectional switch 100b includes switch devices 102b and 104b and has a current terminal 106b coupled to AC terminal 802 and a current terminal 116b coupled to switching terminal 806b, and capacitor 810b is coupled between switching terminal 806b and AC terminal 804. Bidirectional switch 100b also has a substrate bias terminal 120b. The example shown in FIG. 8 is an example of AC half-bridge cycloconverter. In some examples, capacitors 810a and 810b can be replaced by bidirectional switches 100. In such examples, AC cycloconverter 800 can be an AC full-bridge cycloconverter.

AC cycloconverter 800 also includes a bidirectional switch driver 850a and a bidirectional switch driver 850b. Bidirectional switch driver 850a is coupled to switch control terminals 108a and 118a of bidirectional switch 100a, and bidirectional switch driver 850b is coupled to switch control terminals 108a and 118a. AC cycloconverter 800 also includes a substrate bias circuit 300a coupled to current terminals 106a and 116a and substrate bias terminal 120a, and a substrate bias circuit 300b coupled to current terminals 106b and 116b and substrate bias terminal 120b. Both substrate bias circuits 300a and 300b are examples of substrate bias circuit 300 of FIGS. 3-7.

Also, AC terminals 802 can be coupled to an AC source 810, which supplies an AC current 812, and AC terminal 804 can be coupled to ground. In some examples, AC source 810 can include a resonant tank current source connected to a direct current (DC) source (e.g., a solar cell, a battery, a DC power source, etc.). Switching terminal 806a can be coupled via an inductor 820a to an AC output 822a, and switching terminal 806b can be coupled via an inductor 820b to an AC output 822b.

Through the switching of bidirectional switches 100a and 100b, AC cycloconverter 800 can provide an AC voltage (Vout_AC) across AC outputs 822a and 822b. In a first half cycle of the AC voltage, bidirectional switch driver 850a can maintain switch device 102a in the on-state, and toggle switch device 104a between on-state and off-state. Also, bidirectional switch driver 850b can toggle switch device 102b between on-state and off-state, and maintain switch device 104b in the on-state. Also, in a second half cycle of the AC voltage, bidirectional switch driver 850a can maintain switch device 104a in the on-state, and toggle switch device 102a between on-state and off-state. Also, bidirectional switch driver 850b can toggle switch device 104b between on-state and off-state, and maintain switch device 102b in the on-state.

In both positive and negative half cycles, substrate bias circuits 300a can set the substrate voltage of bidirectional switch 100a based on the minimum of the voltages at current terminals 106a and 116a, and substrate bias circuits 300b can set the substrate voltage of bidirectional switch 100b based on the minimum of the voltages at current terminals 106b and 116b.

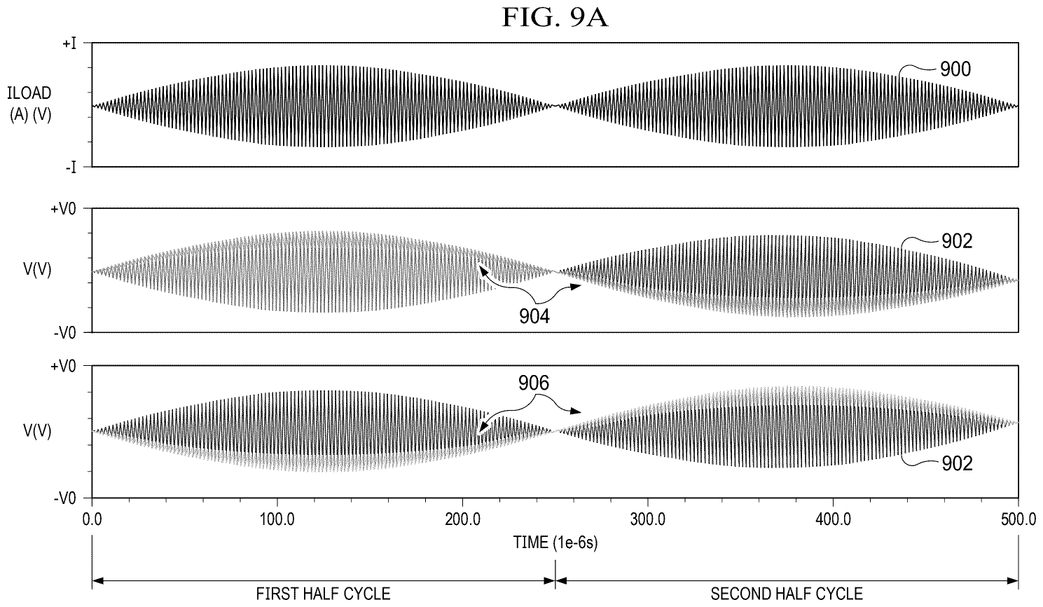

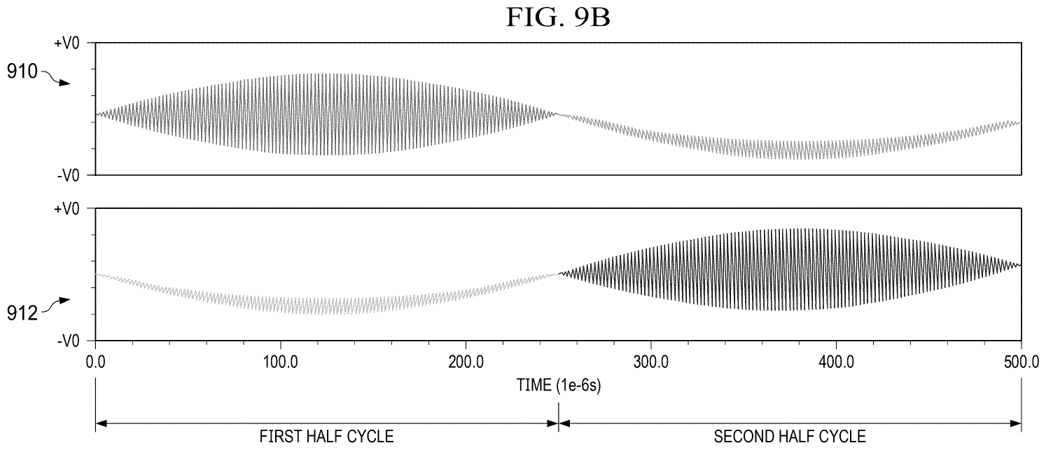

FIG. 9A and FIG. 9B include graphs that illustrate example operations of AC cycloconverter 800. FIG. 9A includes graphs 900, 902, 904, and 906. FIG. 9B includes graphs 910 and 912. Graph 900 illustrates an example variation of AC current 812 with time. Graph 902 illustrates an example variation of the voltage at AC terminal 802 with time. Graph 904 illustrates an example variation of the voltage at AC output 822a with time. Graph 906 illustrates an example variation of the voltage at AC output 822b with time. Graph 910 illustrates an example variation of the substrate voltage of bidirectional switch 100a with time. Graph 912 illustrates an example variation of the substrate voltage of bidirectional switch 100b with time.

Referring to FIG. 9A and FIG. 9B, during both the first half cycle and second half cycle, the voltage at AC terminal 802 swings between symmetrical positive voltage +V0 and negative voltages −V0 around 0V, where the amplitude of the voltage swing tracks the AC current 812, which swings between −I and +I. In some examples, V0 can be at 600V. Also, in the first half cycle, the voltage at AC terminal 802 (and current terminal 106a) remains largely below the voltage at AC output 822a (and current terminal 116a), and as shown in graph 910 of FIG. 9B, substrate bias circuit 300a sets the substrate voltage of bidirectional switch 100a to track the voltage at AC terminal 802 (and current terminal 106a). Also, in the second half cycle, the voltage at AC output 822a (and current terminal 116a) remains largely below (or at the lower end of) the voltage at AC terminal 802 (and current terminal 106a), and substrate bias circuit 300a sets the substrate voltage of bidirectional switch 100a to track the voltage at AC output 822a (and current terminal 116a).

Also, in the first half cycle, the voltage at AC output 822b (and current terminal 116b) remains largely below the voltage at AC terminal 802 (and current terminal 106b), and substrate bias circuit 300b sets the substrate voltage of bidirectional switch 100b to track the voltage at AC output 822b (and current terminal 116b). Also, in the second half cycle, the voltage at AC terminal 802 (and current terminal 106b) remains largely below (or at the lower end of) the voltage at AC output 822b (and current terminal 116b), and substrate bias circuit 300b sets the substrate voltage of bidirectional switch 100b to track the voltage at AC terminal 802 (and current terminal 106b).

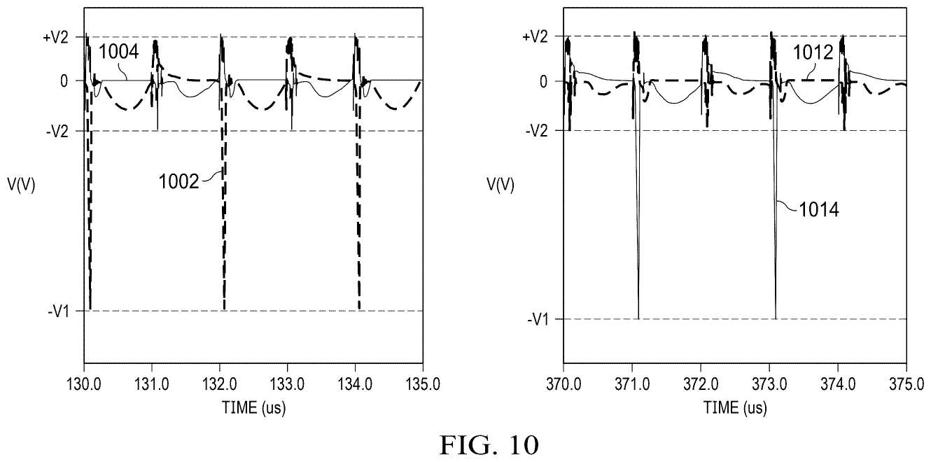

FIG. 10 includes graphs that illustrate the substrate-source voltage difference of bidirectional switches 100a and 100b based on graphs 902-910 of FIG. 9. Graph 1002 illustrates example variation of voltage difference between current terminal 106a and substrate bias terminal 120a with time during the first half cycle. Graph 1004 illustrates example variation of voltage difference between current terminal 116b and substrate bias terminal 120b with time during the first half cycle. Graph 1012 illustrates example variation of voltage difference between current terminal 116a and substrate bias terminal 120a with time during the second half cycle. Graph 1014 illustrates example variation of voltage difference between current terminal 106b and substrate bias terminal 120b with time during the second half cycle.

Referring to graph 1002, during the first half cycle, substrate bias circuit 300a sets the substrate voltage of bidirectional switch 100a to track the voltage at current terminal 106a (and AC terminal 802), including when the voltage at AC terminal 802 switches at time 130us, 132us, and 134us. At those times, the voltage difference between the substrate of bidirectional switch 100a and current terminal 106a increases and peaks at about −V1, which is smaller than V0, and then back to 0V, due to delay in substrate bias circuit 300a. In some examples, V1 is at 15V or lower. The V1 voltage difference is relatively small compared with the switching of source voltages VS1 and VS2 (e.g., +/−V1) and may not cause backgating in bidirectional switch 100a. Also, referring to graph 1004, substrate bias circuit 300b sets the substrate voltage of bidirectional switch 100b to track the voltage at current terminal 116b (and AC output 822b), which experiences much less swing than the voltage at AC terminal 802 during the first half cycle, and the peak voltage difference between the substrate and current terminal 116b of bidirectional switch 100b is within +/−V2, where V2 is smaller than V1.

Also, referring to graph 1014, during the second half cycle, substrate bias circuit 300b sets the substrate voltage of bidirectional switch 100b to track the voltage at current terminal 106b (and AC terminal 802), including when the voltage at AC terminal 802 switches at time 371us, 373us, and 375us. At those times, the voltage difference between the substrate of bidirectional switch 100b and current terminal 116b also increases and peaks at about-V1, and then back to 0V, due to delay in substrate bias circuit 300b, but the 15V voltage difference is also relatively small and does not cause backgating in bidirectional switch 100b. Also, referring to graph 1012, substrate bias circuit 300a sets the substrate voltage of bidirectional switch 100a to track the voltage at current terminal 116a (and AC output 822a), which experiences much less swing than the voltage at AC terminal 802 during the second half cycle, and the peak voltage difference between the substrate and current terminal 116a of bidirectional switch 100a is also within +/−V1.

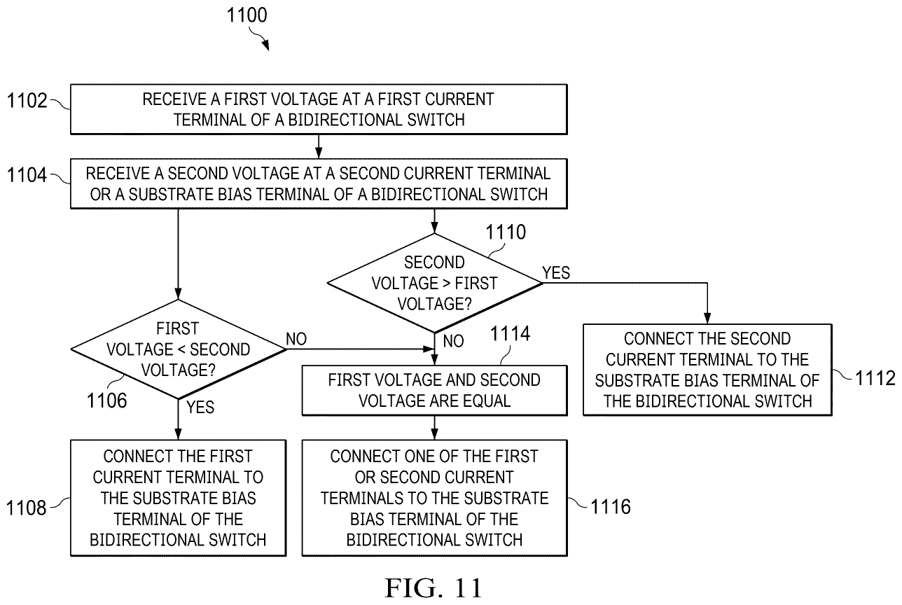

FIG. 11 illustrates a flowchart of a method 1100 of controlling the substrate voltage of a bidirectional switch, such as bidirectional switch 100. Method 1100 can be performed by substrate bias circuit 300 of FIGS. 3-8.

In operation 1102, substrate bias circuit 300 receives a first voltage at a first current terminal of a bidirectional switch, such as current terminal 106 of bidirectional switch 100. The first voltage can be VS1.

In operation 1104, substrate bias circuit 300 receives a second voltage. The second voltage can be at a second current terminal of the bidirectional switch (VS2), or can be at the substrate bias terminal of the bidirectional switch, which can represent the minimum of the first and second source voltages (VS1 and VS2) of the bidirectional switch.

In operation 1106, substrate bias circuit 300 determines whether the first voltage is lower than the second voltage. If the first voltage is lower than the second voltage, substrate bias circuit 300 proceeds to operation 1108 and connects the first current terminal to the substrate bias terminal of the bidirectional switch, to set the substrate voltage based on the first voltage.

In operation 1110, substrate bias circuit 300 determines whether the second voltage is lower than the first voltage. If the second voltage is lower than the first voltage, substrate bias circuit 300 proceeds to operation 1112 and connects the second current terminal to the substrate bias terminal of the bidirectional switch, to set the substrate voltage based on the second voltage.

If from both operation 1106 and 1110, the first voltage is neither larger than or smaller than the second voltage, substrate bias circuit 300 can proceed to operation 1114 and determine that the first and second voltages are equal, and then proceed to operation 1116 and connect one of the first or second current terminals to the substrate bias terminal. Operations 1114 and 1116 can be performed by, for example, logic circuit 408 of FIG. 7.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “on” or “enabled” means that the conduction channel of the FET is present and drain current may flow through the FET. References herein to a FET being “off” or “disabled” means that the conduction channel is not present so drain current does not flow through the FET. An “off” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description.

In this description, unless otherwise stated, “about,” “approximately” or “substantially” preceding a parameter means being within +/−10 percent of that parameter or, if the parameter is zero, a reasonable range of values around zero.

Terms “and” and “or,” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Although various examples have been described in detail, it should be understood that various changes, substitutions, and alterations can be made therein without departing from the scope defined by the appended claims. The devices, structures, materials, and processes discussed above are examples. Various examples may omit, substitute, or add various procedures or components as appropriate. Also, features described with respect to certain examples may be combined in various other examples. Different aspects and elements of the examples may be combined in a similar manner. Also, technology evolves and, thus, many of the elements are examples that do not limit the scope of the disclosure to those specific examples.

Specific details are given in the description on order to provide a thorough understanding of the examples. However, examples may be practiced without these specific details. For example, well-known circuits, processes, systems, structures, and techniques may have been shown without unnecessary detail in order to avoid obscuring the examples. This description provides examples only, and is not intended to limit the scope, applicability, or configuration of the invention. Rather, the preceding description of the examples will provide those skilled in the art with an enabling description for implementing various examples. Various changes may be made in the function and arrangement of elements without departing from the spirit and scope of the present disclosure. Modifications are possible in the described examples, and other examples are possible, within the scope of the claims.

What is claimed is:

1. An apparatus comprising:
a bidirectional switch substrate bias circuit comprising:
a first switch coupled between a substrate bias terminal and a first switch current terminal, the first switch having a first switch control terminal;
a second switch coupled between the substrate bias terminal and a second switch current terminal, the second switch having a second switch control terminal; and
a control circuit having first and second inputs and first and second outputs, the first and second inputs coupled to the respective first and second switch current terminals, and the first and second outputs coupled to the respective first and second switch control terminals, the control circuit configured to, responsive to respective states of the first and second inputs, enable one of the first or second switches and disable the other one of the first or second switches.

2. The apparatus of claim 1, wherein the control circuit is configured to:
receive a first voltage at the first input;
receive a second voltage at the second input;
responsive to the first voltage being lower than the second voltage, enable the first switch and disable the second switch;
responsive to the second voltage being lower than the first voltage, enable the second switch and disable the first switch; and
responsive to the first voltage being equal to the second voltage, enable one of the first or second switches and disable the other one of the first or second switches.

3. The apparatus of claim 1, wherein the control circuit has a third input coupled to the substrate bias terminal, and the control circuit is configured to:
receive a first voltage at the first input;
receive a second voltage at the second input;
receive a third voltage at the third input;
responsive to the first voltage being lower than the third voltage, enable the first switch and disable the second switch;
responsive to the second voltage being lower than the third voltage, enable one of the first or second switches and disable the other one of the first or second switches; and
responsive to at least one of the first voltage or the second voltage being equal to the third voltage, enable one of the first or second switches and disable the other one of the first or second switches.

4. The apparatus of claim 1, wherein the control circuit includes:
a bias generator having a bias output;
a first transistor coupled between the first switch current terminal and the first switch control terminal, the first transistor having a first transistor control terminal coupled to the bias output; and
a second transistor coupled between the second switch current terminal and the second switch control terminal, the second transistor having a second transistor control terminal coupled to the bias output.

5. The apparatus of claim 4, wherein the control circuit includes:
a third transistor coupled between the first switch control terminal and the substrate bias terminal; and
a fourth transistor coupled between the second switch control terminal and the substrate bias terminal.

6. The apparatus of claim 5, wherein the third transistor has a third transistor control terminal coupled to the second switch control terminal, and the fourth transistor has a fourth transistor control terminal coupled to the first switch control terminal.

7. The apparatus of claim 6, wherein the control circuit includes:
a first resistor coupled between the third transistor control terminal and the bias output;
a second resistor coupled between the fourth transistor control terminal and the bias output;
a fifth transistor coupled between the bias output and the substrate bias terminal, the fifth transistor having a fifth transistor control terminal coupled to the first switch control terminal;
a sixth transistor coupled between the bias output and the substrate bias terminal, the sixth transistor having a sixth transistor control terminal coupled to the second switch control terminal;
a third resistor coupled between the bias output and the fifth transistor; and
a fourth resistor coupled between the bias output and the sixth transistor.

8. The apparatus of claim 4, further comprising a maximum voltage selector having inputs coupled to the first and second switch current terminals, wherein the bias generator is coupled between an output of the maximum voltage selector and the substrate bias terminal.

9. The apparatus of claim 8, wherein the maximum voltage selector includes a first diode-connected fifth transistor coupled between the first switch current terminal and the output, and a second diode-connected sixth transistor coupled between the second switch current terminal and the output.

10. The apparatus of claim 8, wherein the bias generator includes:
a bias current generator and a current source coupled to the output of the maximum voltage selector, the current source having a control input coupled to an output of the bias current generator and an output coupled to the bias output; and
a plurality of diode-connected transistors coupled between the bias output and the substrate bias terminal.

11. The apparatus of claim 4, wherein the first and second switches and the control circuit include high electron mobility (HEMT) devices.

12. The apparatus of claim 4, wherein the bias generator includes enhance mode and depletion mode HEMT devices.

13. The apparatus of claim 4, further comprising a bidirectional switch having the first and second switch current terminals, the bidirectional switch having HEMT devices.

14. The apparatus of claim 13, wherein the bidirectional switch and the bidirectional switch bias circuit are implemented on a same semiconductor die or in a same integrated circuit package.

15. An apparatus comprising:
a first bidirectional switch having a first current terminal and a second current terminal, the first current terminal coupled to an alternating current (AC) terminal, the second current terminal coupled to a first switching terminal, the first bidirectional switch having a first substrate bias terminal;
a second bidirectional switch having a third current terminal and a fourth current terminal, the third current terminal coupled to the AC terminal, and the fourth current terminal coupled to a second switching terminal, the second bidirectional switch having a second substrate bias terminal;
a first substrate bias circuit including:
a first switch coupled between the first current terminal and the first substrate bias terminal, the first switch having a first switch control terminal;
a second switch coupled between the second current terminal and the first substrate bias terminal, the second switch having a second switch control terminal; and
a first control circuit having first and second inputs and first and second outputs, the first and second inputs coupled to the respective first and second current terminals, and the first and second outputs coupled to the respective first and second switch control terminals, the first control circuit configured to, responsive to respective states of the first and second inputs, enable one of the first or second switches and disable the other one of the first or second switches; and
a second substrate bias circuit including:
a third switch coupled between the third current terminal and the second substrate bias terminal, the third switch having a third switch control terminal;
a fourth switch coupled between the fourth current terminal and the second substrate bias terminal, the fourth switch having a fourth switch control terminal; and
a second control circuit having third and fourth inputs and third and fourth outputs, the third and fourth inputs coupled to the respective third and fourth current terminals, and the third and second outputs coupled to the respective first and second switch control terminals, the second control circuit configured to, responsive to respective states of the third and fourth inputs, enable one of the third or fourth switches and disable the other one of the third or fourth switches.

16. The apparatus of claim 15, wherein the first control circuit is configured to:
receive a first voltage at the first input;
receive a second voltage at the second input;
responsive to the first voltage being lower than the second voltage, enable the first switch and disable the second switch;
responsive to the second voltage being lower than the first voltage, enable the second switch and disable the first switch; and
responsive to the first voltage being equal to the second voltage, enable one of the first or second switches and disable the other one of the first or second switches.

17. The apparatus of claim 15, wherein the second control circuit is configured to:
receive a first voltage at the third input;
receive a second voltage at the fourth input;
responsive to the first voltage being lower than the second voltage, enable the third switch and disable the fourth switch;
responsive to the second voltage being lower than the first voltage, enable the fourth switch and disable the third switch; and
responsive to the first voltage being equal to the second voltage, enable one of the third or fourth switches and disable the other one of the third or fourth switches.

18. The apparatus of claim 15, further comprising:
a first capacitor or a third bidirectional switch coupled between the first switching terminal and a ground terminal; and
a second capacitor or a fourth bidirectional switch coupled between the second switching terminal and the ground terminal.

19. A method comprising:
receiving a first voltage at a first current terminal of a bidirectional switch;
receiving a second voltage at a second current terminal or a substrate bias terminal of the bidirectional switch;
responsive to the first voltage lower than the second voltage, connecting the first current terminal to the substrate bias terminal; and
responsive to the second voltage lower than the first voltage, connecting the second current terminal to the substrate bias terminal.

20. The method of claim 19, further comprising: responsive to the first and second voltages being equal, connecting one of the first or second current terminals to the substrate bias terminal.
